(19) United States
(12) Patent Application Publication
(10) Pub. No.: US 2011/0264642 A1
(43) Pub. Date: Oct. 27, 2011

(54) DYNAMIC COMPUTATION ENGINE IN SEARCH STACK

(75) Inventors: Vijay Mital, Kirkland, WA (US); Thomas Frank Bergstraesser, Kirkland, WA (US); Darryl Ellis Rubin, Duvall, WA (US)

(73) Assignee: Microsoft Corporation, Redmond, WA (US)

(21) Appl. No.: 12/767,188

(22) Filed: Apr. 26, 2010

(51) Int. Cl. G06F 17/30

(52) U.S. Cl. 707/706; 707/769; 707/E17.108

(57) ABSTRACT

A data search and retrieval system that, in response to a search query, dynamically selects and applies a model of information to be returned to a user. The model may be selected based on the search query directly, or indirectly based on data returned by a search engine applying the query. For this purpose, the system may include an index of models, similar to a search index. Models may include expressions that may be descriptions of computations, equations, constraints or rules to define information to be returned. These elements of a selected model may be executed within to the search stack based on data identified in a search of web pages by executing the query or other dynamically obtained data. Execution of a model may lead to collecting new information, such as through further searching or performing computations, or may result in ordering or other formatting of data.

### BACKGROUND

With the widespread availability of information over networks, such as the Internet, search engines have come into widespread use. Search engines receive user queries and find content matching the query to return to the user. A common approach to implementing a search engine is through a page index. The page index relates terms that may appear in a search query to units of content on the network, frequently called web pages.

Various approaches exist for constructing and applying the page index. Constructing the index frequently entails “crawling” a network, such as the Internet, containing the body of data that will eventually be searched. Crawling entails following links from one web page to the next and analyzing each page. As part of the analysis, terms characterizing the web page may be identified and added to the page index in a way that associates that web page with those terms. Additionally, information, such as the number of links to a web page, may be captured and used to prioritize the web pages.

The page index is applied as part of a search stack. When a user submits a search query, a search engine matches terms in the query to web pages based on the search index. The search stack may include components that modify the search query before the index is consulted, such as to correct misspelling of search terms or attach terms that can be inferred based on a user profile. The search stack may also include components to filter search results. For example, web pages identified using the page index may be filtered, such as by ranking the web pages based on a metric indicating relevance to a query.

In some scenarios, information that may be useful as part of processing search queries may be pre-computed. An entry may be made in the page index, pointing to the pre-computed information rather than a web page.

### SUMMARY

The usefulness of a search system may be improved by incorporating into a search stack of the system components that may select and execute a model characterizing information to be provided in response to a search query. The model may be selected from a set of models based on user context information, such as a search query from a user and/or data identified by a search engine in response to the search query.

Execution of the model may result in generation of new information, in addition to formatting, filtering or processing data returned by a search engine executing the query. The new information may be generated based on an expression contained in the model and may include expressions that may be evaluated based on dynamic data, including data based on a search query.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a high level block diagram illustrating a computing environment in which some embodiments of the invention may be practiced;

FIG. 2 is an architectural block diagram of a search stack according to some embodiments;

FIG. 3 is a diagram of types of statements that may comprise the specification of a declarative model;

FIG. 4 is a diagram of an example of statements, such as those that may be specified for the declarative model of FIG. 3;

FIG. 5 is a flowchart of a process that may be performed during execution by a search stack, according to some embodiments; and

FIG. 6 is an example of a user interface via which a user may enter a search query and display information returned in response to the query.

### DETAILED DESCRIPTION

The inventors have recognized and appreciated that functionality and utility of search systems may be expanded by incorporating into a search stack of a search system components that can select and execute one or more models characterizing data to be provided to a user in the user's context, and also characterizing the interactions between the data and user. In response to a search query, or other input identifying user context, the system may identify a model to apply in generating information for the user and to handle further interactions between the user and the information (as the user seeks to better understand the information or subsets of the information, including by providing more data). The model may be selected based on user context information, that may include the search query itself or data generated by a search engine applying the search query to select web pages.

Once a model is selected, a model execution engine may apply the model to generate information to be provided to the user. A model may include one or more elements, at least some of which define a computation to be performed based on data dynamically identified for the user's context. For example, execution of the model may result in a computation that has inputs relating to terms in the search query or data generated by a search engine applying the search query. The output of the computation may be provided to the user as a result of the search query, either alone or in conjunction with data located by a search engine or other dynamically generated data.

In some embodiments, the computation may be based on an equation represented in the model. The equation may specify a mathematical operation to be performed on data that is dynamically identified by the search engine. Such a mathematical operation may include other data, such as user data obtained from a user profile or based on context information. Executing models in a search stack may greatly expand the type of information that may be returned to a user and may be applied in many different contexts.

For example, a model may include an equation, defining computation of calorie content from a recipe. Such a model may be applied in response to a query requesting recipes such that, in addition to receiving content representing recipes found on web pages, a user may receive calorie content, even though that information was not included on the web pages. Such a model may allow the user to interact with the data returned by the query without going back to the search engine. For example, if a facility is provided to edit a model, a user may specify or change his personal profile and nutrition goals by editing the model and see alternative meal plans for the day.

As another example, a model may include a formula for computing commuting distance or time from a location. Such a model may be applied in response to a query requesting information on houses for sale such that, in addition to receiving a listing of houses for sale identified as a result of a search, a user may receive commuting information with each house. A system may support user edits to the commuting model to let the user interact with and do “what-ifs” with the information, e.g. the commuting impact of particular school/gym/workplace/transportation mode choices.

As yet another example, a model may include a formula for generating a metric comparing a patient's lab results to a population norm. Such a model may be applied in a search system coupled to an intranet in a hospital such that, when a search is conducted for lab results of a patient, a clinician may receive, in addition to lab results for the patient, comparative data characterizing the results based on an analysis of lab results in medical records for other users returned as a result of the search. The model may enable the clinician to do what-ifs like change some assumptions about the patient or the relationship between lab data and underlying disease.

A search system may contain multiple models, applicable in different contexts. Accordingly, a search system may contain a component that selects a model for a specific context. A component to perform this function may access a model index. In some embodiments, the model index may have a form analogous to a page index used by a search engine. In this way, existing techniques optimized for high speed search may also be used to quickly select and apply a model. Such an approach may be useful in scenarios in which a model is identified based on terms or other aspects of a search query. Further, in some embodiments, the models may be treated as web pages and may include meta tags to aid in indexing them in a search engine.

To facilitate the use of models, each model may be represented as a collection of declarative statements (“expressions”). An expression may be a symbolic representation of a computation to be performed, which may consist of operators and operands. The operators of an expression may include any operators known to one of skill in the art (such as the common mathematical operators of addition, subtraction, multiplication, and division), any functions known to one of skill in the art, and functions defined by a user. The operands of an expression may include data (such as numbers or strings), symbols that represent data, and other expressions. An expression may thus be recursive in that an expression may be defined by other expressions.

A symbol may represent any type of data used in common programming languages or known to one of skill in the art. For example, a symbol may represent an integer, a rational number, a string, a Boolean, a sequence of data (potentially infinite), a tuple, or a record. In some embodiments, a symbol may also represent irrational numbers, while in other embodiments, symbols may not be able to represent irrational numbers.

For example, an expression may take the form of a symbolic representation of an algebraic expression, such as x²+2xy+y², where x and y may be symbols that represent data or other expressions. An expression may take the form of an equation, such as E=mc², where E, m, and c may by symbols representing data or other expressions. An expression may take the form of a function definition, such as ƒ(x)=x²−1, where ƒ is a symbol representing the function, x is a symbol representing an operand or argument of the function, and x²−1 is an expression that defines the function. An expression may also take the form of a function invocation, such as ƒ(3), which indicates that the function ƒ is to be invoked with an argument of 3.

Expressions may be solved by an expression engine to produce a result. For example, where the symbol x (itself an expression) represents the number 3 and the symbol y (also an expression) represents the number 2, the expression x²+2xy+y² may be solved by replacing the symbols with the values the represent, e.g., 2²+2×2×3+3², and then applying the operators to the operands to solve the entire expression as 25. In another example, where m is a symbol representing the number 2 and c is a symbol representing the number 3, the expression E, defined above, may be solved by replacing E with its definition, e.g., mc², replacing the symbols m and c with the values they represent, e.g., 2×3², and applying the operators to the operands to solve the expression as 18.

In evaluating an expression, the expression engine may apply the operators to the operands to the extent that the operators and operands are defined and to the extent that expression engine knows how to apply the operators to the operands. For example, where the symbol x represents the number 3 and the symbol y is not defined, the expression x²+2xy+y² may be solved by replacing the known symbols with the values the represent, e.g., 2²+2×2×y+y², and then applying the operators to the operands to solve the entire expression as 4+4y+y². Where the symbol x represents the number 3 and the symbol y represents the string “hello”, the expression x²+2xy+y² may be solved as 4+4×hello+hello², since the expression engine may not know how to perform arithmetic operations on the string “hello.”

In some embodiments, expressions may be declarative. A declarative expression may indicate a computation to be performed without specifying how to compute it. A declarative expression may be contrasted with an imperative expression, which may provide an algorithm for a desired result.

In some embodiments, expressions may be immutable. An expression is immutable if it cannot be changed. For example, once a definition is given, such as E=mc², the expression E cannot later be given a different definition. One advantage of immutability is that applications defined by immutable expressions may be side-effect free in that the functionality of the application may not be able to be altered by users of the application.

An application may be defined by a set of expressions, aka a model. An application defined by expressions may have input variables and output variables and the relationship between the input variables and the output variables may be defined by the set of expressions that defines the application. The determination of which variables are input variables and which variables are output variables may be determined by the user. In solving for the output variables, the expression engine may produce data (e.g., a number or a string) or may produce an expression of the input variables.

In this way, the models may be relatively easy to produce and apply. Further, by having the models executed in a model engine, an entity providing search services may receive models from third parties and execute them in an environment in which execution of the model cannot interfere with operation of the computer equipment that implements the search system.

As a result, knowledge useful in generating search results may be captured in models and shared across search systems. Further, by allowing the models to be executed in the search stack of a search system, models may perform computations or other operations based on data that is only available within the search system.

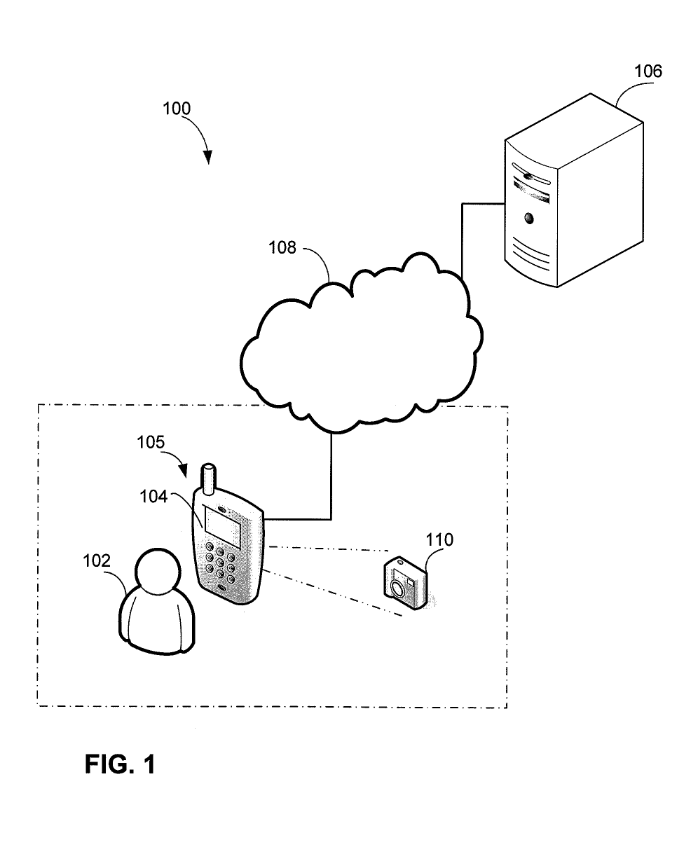

FIG. 1 is a high level diagram illustrating a computing environment 100 in which some embodiments of the invention may be practiced. Computing environment 100 includes a user 102 interacting with a computing device 105. Computing device 105 may be any suitable computing device, such as a desktop computer, a laptop computer, a mobile phone, or a PDA. Computing device 105 may operate under any suitable computing architecture, and include any suitable operating system, such as variants of the WINDOWS® Operating System developed by MICROSOFT® Corporation.

Computing device 105 may have the capability to communicate over any suitable wired or wireless communications medium to a server 106. The communication between computing device 105 and server 106 may be over computer network(s) 108, which may be any suitable number or type of telecommunications networks, such as the Internet, a corporate intranet, or cellular networks. Server 106 may be implemented using any suitable computing architecture, and may configured with any suitable operating system, such as variants of the WINDOWS® Operating System developed by MICROSOFT® Corporation. Moreover, while server 106 is illustrated in FIG. 1 as being a single computer, it may be any suitable number of computers configured to operate as a coherent system.

In the example of FIG. 1, server 106 operates as a search engine, allowing user 102 to retrieve information relevant to a search query. The user may specify the query explicitly, such as by inputting query terms into computing device 105 in any suitable way, such as via a keyboard, key pad, mouse, or voice input. Additionally and/or alternatively, the user may provide an implicit query. For example, computing device 105 may be equipped with (or connected via a wired or wireless connection to) a digital camera 110. An image, such as of an object, a scene, or a barcode scan, taken from digital camera 110 may serve as an implicit query.

Regardless of the type of input provided by user 102 that triggers generation of a query, computing device 105 may send the query to server 106 to obtain information relevant to the query. After retrieving data relevant to the search query, such as, for example, web pages, server 106 may apply one or more declarative models to the data to generate higher level information to be returned to user 102. The information generated by server 106 may be sent over computer network(s) 108 and be displayed on display 104 of computing device 105. Display 104 may be any suitable display, including an LCD or CRT display, and may be either internal or external to computing device 105.

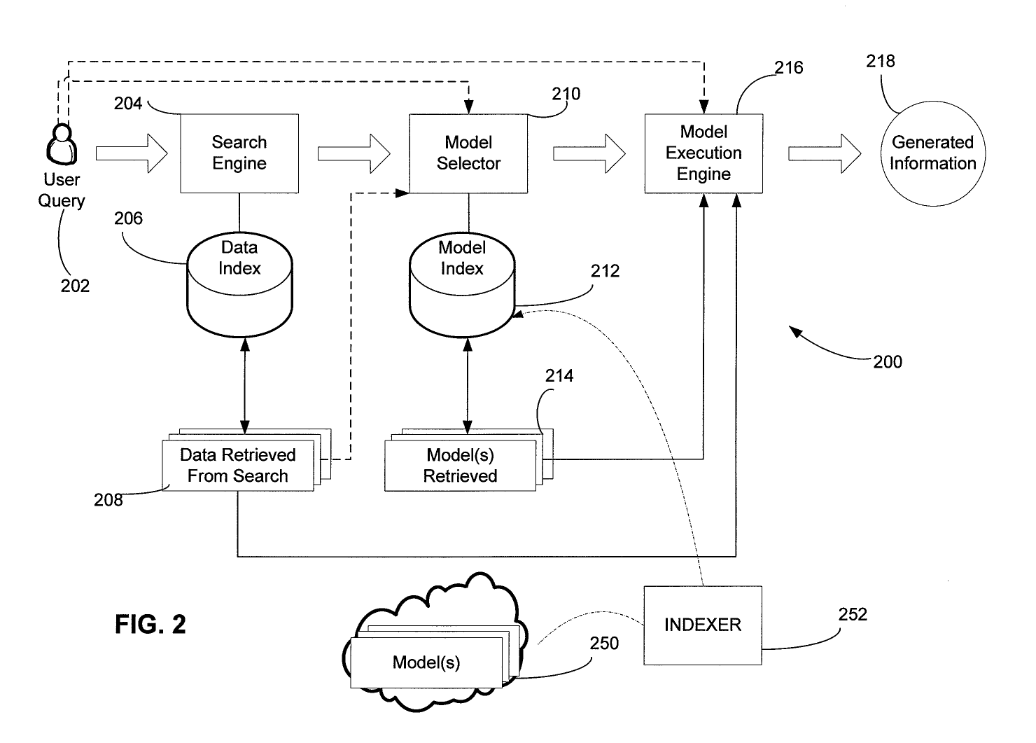

FIG. 2 is an architectural block diagram of a search stack 200 according to some embodiments, such as may be implemented by server 106 of FIG. 1. The components of search stack 200 may be implemented using any suitable configuration and number of computing devices, such as for purposes of load-balancing or redundancy. For example, the functionality described in connection with each component of the search stack may be performed by different physical computers configured to act as a coherent system, and/or a single physical computer may perform the functionality ascribed to multiple components. In addition, in some embodiments, some of the functionality ascribed to a single component of the search stack may be distributed to multiple physical computers, each of which may perform a different portion of the computation in parallel.

Regardless of the specific configuration of search stack 200, a user query 202 may be provided as input to search stack 200 over a computer networking communications medium, and may be either implicit or explicit, as discussed in connection with FIG. 1. In the example of FIG. 2, user query 200 is provided to an input component in search stack 200, such as search engine 204, which may be any suitable search engine, such as the BING® search engine developed by Microsoft Corporation. Search engine 204 may be coupled to one or more storage media comprising a data index 206. Data index 206 may be stored on any suitable storage media, including internal or locally attached media, such as a hard disk, storage connected through a storage area network (SAN), or networked attached storage (NAS). Data index 206 may be in any suitable format, including one or more unstructured text files, or one or more relational databases.

Search engine 204 may consult data index 206 to retrieve data 208 related to the user query 202. The retrieved data 208 may be a data portion of search results that are retrieved based on user query 202 and/or other factors relevant to the search, such as a user profile or user context. That is, data index 206 may comprise a mapping between one or more factors relevant to a search query (e.g., user query terms, user profile, user context) and data, such as data pages, that match and/or relate to that query. The mapping in data index 206 may be implemented using conventional techniques or in any other suitable way.

Regardless of the type of mapping performed using data index 206 to retrieve data 208 relevant to the search, data 208 may comprise any suitable data retrieved by search engine 204 from a large body of data, such as, for example, web pages, medical records, lab test results, financial data, demographic data, video data (e.g., angiograms, ultrasounds), or image data (e.g., x-rays, EKGs, VQ scans, CT scans, or MRI scans). Data 208 may be retrieved or identified dynamically by search engine 204 or it may be cached as the result of a prior search performed by search engine 204 based on similar or identical query. Data 208 may be retrieved using conventional techniques or in any other suitable way.

The search stack 200 may also include a model selection component, such as model selector 210, which may select one or more appropriate declarative model(s) 214 from a set of models stored on one or more computer readable media accessible to the model selector 210. The model selector 210 may then apply the selected model(s) 214 to the results (i.e., data 208) of the search performed by search engine 204, Model selector 210 may be coupled to model index 212, which may be the same as data index 206 or may be a separate index. Model index 212 may be implemented on any suitable storage media, including those described in connection with data index 206, and may be in any suitable format, including those described in connection with data index 206. Model index 212 may comprise a mapping between one or more factors relevant to the user's search (e.g., terms in user query 202, user profile, user context, and/or the data 208 retrieved by the search engine 204) and appropriate model(s) 214 that may be applied to the data 208 retrieved by search engine 204.

Selected models 214 may be selected from a larger pool of models 250 stored on computer-readable media associated with server 106 (FIG. 1). In some embodiments, pool of models 250 may be supplied by an entity operating the search system. Though, in other embodiments, all or a portion of the models in pool of models 250 from which models 214 are selected may be provided by parties other than the entity operating the search system. In some embodiments, models in pool of models 250 may be supplied by a user inputting user query 202. In such a scenario, a portion of pool of models 250 accessed by model selector 210 may include computer storage media segregated to store data personal to individual users, such as the user submitting user query 202. In other embodiments, a community of users may have access to the search system and pool of models 250 may include models submitted by users other than the user who submitted user query 202. In yet other embodiments, some or all of the models in pool of models 250 from which models 214 were selected may be provided by other third parties. Such third parties may include businesses or organizations that have a specialized desire or ability to specify the nature of information to be generated in response to a search query. For example, a model that computes commuting distance from a house for sale may be provided by a real estate agent. A model that computes comparative lab results may be provided by a medical association. Accordingly, it should be appreciated that any number of types of models may be incorporated in pool of models 250.

In some embodiments, to facilitate easy addition of models to pool of models 250, the search system illustrated in FIG. 2 may include an indexer 252. Indexer 252 may update model index 212 based on models contained within pool of models 250. In some embodiments, each of the models in pool of models 250 may contain meta tags identifying context in which the model may be applied. Indexer 252 may use this information similar to meta tags attached to web pages to construct model index 212. In this regard, indexer 252 may be implemented using technology known in the art for implementing a web crawler to build a page index. To support such an implementation, each of the models in pool of models 250 may be formatted as a web page. However, it should be recognized that any suitable technique may be used for constructing model index 212, including machine learning techniques or explicit human input. Model selector 210 may be implemented using technology known in the art for implementing a search engine based upon an index. However, rather than identifying which pages to return to a user based on a data index, model selector 210 may employ model index 212 to identify models used in generating information to provide to a user. Model selector 210 may identify models based on a precise match between factors relevant to the search and terms in the model index. Though, inexact matching techniques may alternatively or additionally be used. In some embodiments, the declarative models are themselves stored in model index 212, while in other embodiments, the models themselves may be stored separately from model index 212, but in such a way that they may be appropriately identified in model index 212.

Search stack 200 may also include a model execution engine 216, which may apply the selected model(s) 214 to the data 208 retrieved by search engine 204. In the application of a model, data 208 may serve as a parameter over which the selected model(s) is executed by model execution engine 216. Additional parameters, such as portions of user query 202, may also be provided as input to the selected model(s) during model execution. Though, it should be appreciated that any data available within the search environment illustrated in FIG. 2 may be identified in a model and used by model execution engine 216 when the model is applied.

As a result of the application of the model to the search results performed by model execution engine 216, information 218 may be generated. Generated information 218 may be returned to the user by an output component (not shown) of search stack 200. Though, the generated information may be used in any suitable way, including as a query for further searching by search engine 204. Generated information 218 may include the results of model execution performed by model execution engine 216, may include data 208 retrieved by the search engine 204, or any suitable combination thereof. For example, based on the application of a model performed by the model execution engine 216, the ordering of the presentation to a user of data 208 may change, the content presented as part of data 208 may be modified so that it includes additional or alternative content that is the result of a computation performed by model execution engine 216, or any suitable combination of the two. Thus, when selected model(s) 214 are applied to raw data, such as data 208, retrieved by a search engine, the generated information 218 may be at a higher level of abstraction and therefore be more useful to a user than the raw data itself.

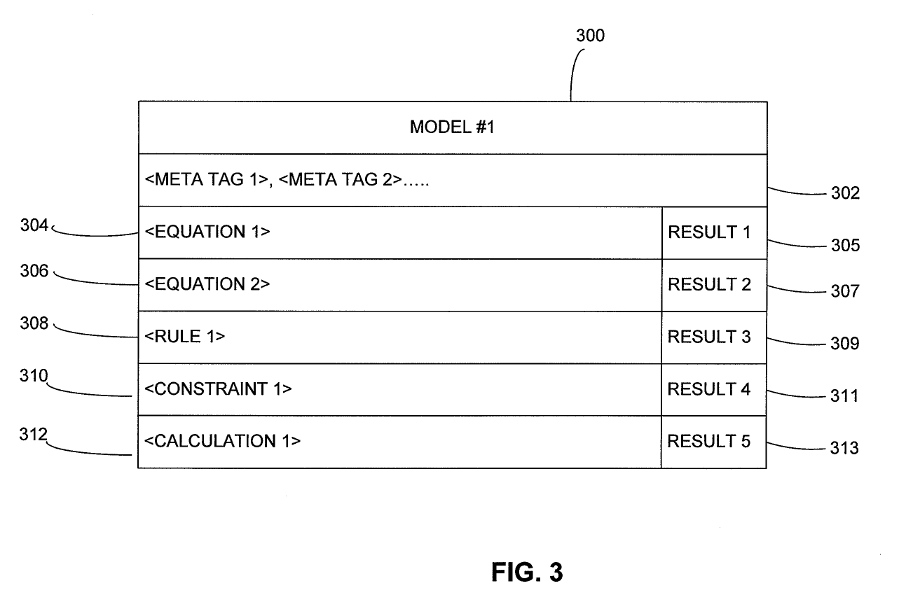

FIG. 3 is a sketch of a data structure string of a declarative model 300, such as one of model(s) 214 selected by model selector 210 of FIG. 2. Model 300 may be stored in any suitable way. In some embodiments, it may be stored in a file, and may be treated as a web page. Accordingly, in such embodiments, like other web pages, model 300 may include meta tags 302 to aid in indexing the model, such as in model index 212 of FIG. 2, thus relating the model to factors such as a query that are relevant to a search.

Model 300 may comprise one or more elements, which in the embodiment illustrated are statements in a declarative language. In some embodiments, the declarative language may be at a level that a human being who is not a computer programmer could understand and author. For example, it may contain statements of equations and the form of a result based on evaluation of the equation, such as equation 304 and result 305, and equation 306 and result 307. An equation may be a symbolic or mathematical computation over a set of input data.

Model 300 may also comprise statement(s) of one or more rules, such as rule 308 and the form of a result based on evaluation of the equation, such as rule result 309. The execution of some types of rules may trigger a search to be performed, thereby collecting new information. According to some embodiments, when a model such as model 300 containing a rule, such as rule 308, is executed, such as by model execution engine 216, the evaluation of the rule performed as part of the execution of the model may generate a search query and trigger a search to be performed by the data search engine, such as search engine 204. Thus, in such embodiments, an Internet search may be triggered based on a search query generated by the application of a model to the search data. Though a rule may specify any suitable result. For example, a rule may be a conditional statement and a result that applies, depending on whether the condition evaluated dynamically is true or false. Accordingly, the result portion of a rule may specify actions to be conditionally performed or information to be returned or any other type of information.

Model 300 may also comprise statement(s) of one or more constraints, such as constraint 310 and result 311. A constraint may define a restriction that is applied to one or more values produced on application of the model. An example of a constraint may be an inequality statement such as an indication that the result of applying a model to data 208 retrieved from a search be greater than a defined value.

Model 300 may also include statements of one or more calculations to be performed over input data, such as calculation 312. Each calculation may also have an associated result, such as result 313. In this example, the result may label the result of the specified calculation 312 such that it may be referenced in other statements within model 300 or otherwise specifying how the result of the computation may be further applied in generating information to a user. Calculation 312 may be an expression representing a numerical calculation with a numerical value as a result, or any other suitable type of calculation, such as symbolic calculations. In applying model 300 to data 208 retrieved by a search engine, model execution engine 216 may perform any calculations over data 208 that are specified in the model specification, including attempting to solve equations, inequalities and constraints over the data 208. In some embodiments, the statements representing equations, rules, constraints or calculations within a model may be interrelated, such that information generated as a result of one statement may be referenced in another statement within model 300. In such a scenario, applying model 300 may entail determining an order in which the statements are evaluated such that all statements may be consistently applied. In some embodiments, applying a model may entail multiple iterations during which only those statements for which values of all parameters in the statement are available are applied. As application of some statements generates values used to apply other statements, those other statements may be evaluated in successive iterations. If application of a statement in an iteration changes the value of a parameter used in applying another statement, the other statement will again be applied based on the changed values of the parameters on which it relies. Application of the statements in a model may continue iteratively in this fashion until a consistent result of applying all statements in the model occurs from one iteration to the next, achieving a stable and consistent result. Though, it should be recognized that any suitable technique may be used to apply a model 300.

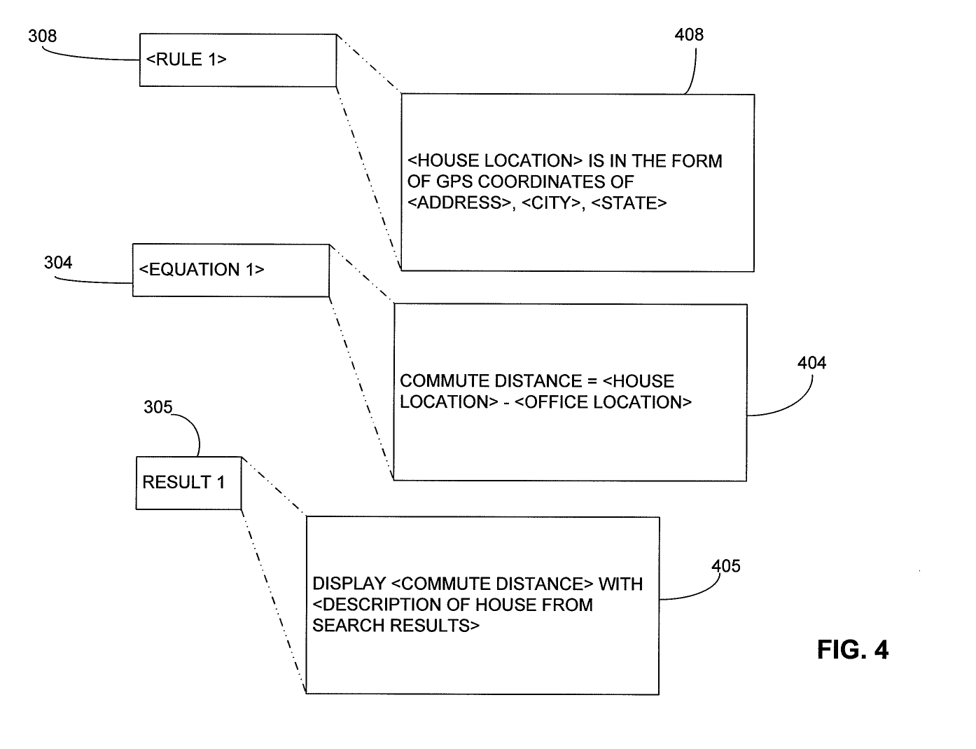

FIG. 4 provides an example of statements such as those that may be specified for model 300. In the example of FIG. 4, the model may be selected and applied when a user is performing a house search, and may in this example, relate houses for sale to the user's commute. Application of the model in the example of FIG. 4 may generate information on the commuting distance and/or time between each house for sale and the user's office location. Thus, rule statement 408 is an example of rule 308 from FIG. 3 that specifies the form of a house location to be used as part of the model computations. In this example, rule statement 408 specifies that a parameter, identified as a house location, be in the form of global positioning system (GPS) coordinates of the address, city and state of the house for sale. These parameters may, when the model is applied, be given values by model execution engine 216 based on retrieved data 208. In this example, rule 308 may evaluate to true when a web page, or other item of retrieved data, contains information that is recognized as a house location by application of rule 308. Accordingly, rule 308 may be used to identify items of data for which other statements within the model are applied.

Equation statement 404 is an example of equation 304 of FIG. 3 that provides a computation to be performed to arrive at the commute distance, based on the location of the house for sale as specified in rule statement 408 and a value that may be available to model execution engine 216, which in this example is indicated as the office location. In this example, the office location is an input parameter to the model that may have been provided, for example, as part of the user query, as part of the user's profile or user context. The house location, however, is based on the application of rule statement 408, received from another input to the model, such as data 208 that are returned as the result of the search engine.

Result statement 405 is an example of result 305 of FIG. 3 that specifies how to display the result of the computation performed for equation statement 404. Thus, result statement 405, in this example, specifies that the commute distance to each house for sale from the search results be displayed alongside the description of the house, which is a parameter for which a value may be established based on data 208.

The example of FIG. 4 illustrates some of the statements that may be present in a model to display results to a user query. In this example, the results relate to houses for sale. Accordingly, the model depicted in FIG. 4 may be selected by model selector 210 (FIG. 2) in response to a user query 202 requesting information on houses for sale. The model may be applied by model execution engine 216 to every item of data in retrieved data 208. Though, not every retrieved item of data may comply with rule 308 or other conditions established by statements within the model. Accordingly, not every item of retrieved data 208 may be included in generated information 218. Though, FIG. 4 illustrates that other information, not expressly included within retrieved data 208, may be included in generated information 218. In the simple example of FIG. 4, a value of a parameter called “commute distance” is computed by model execution engine 216 upon application of the model of FIG. 4.

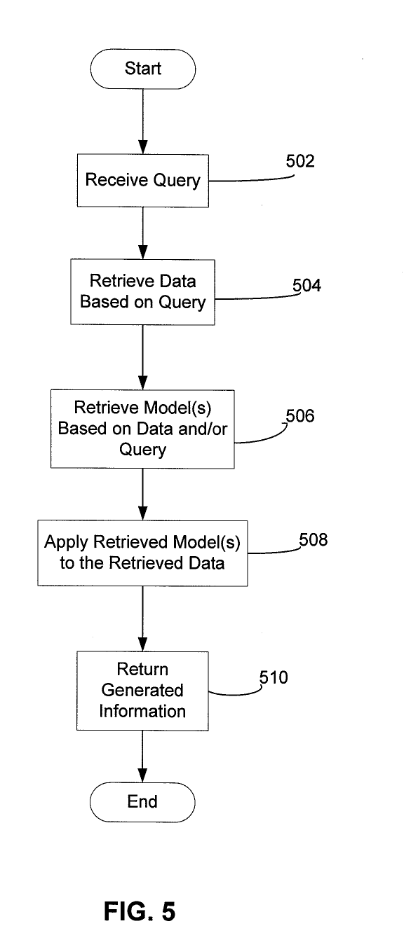

FIG. 5 is a flowchart of a process that may be performed during execution by a search stack, such as search stack 200 of FIG. 2 according to some embodiments. The process may start when a computing device, such as computing device 105 of FIG. 1, sends a search query on behalf of a user to a search engine, such as search engine 204 of FIG. 2. Though, it is not a requirement that the search process be triggered by express user input or express user input in textual form. Non-textual inputs or implied user inputs may be regarded as a query triggering execution of the process of FIG. 5.

In step 502, the search stack may receive the user's query. As discussed above, a user's query may be either implicit or explicit. For example, in some embodiments, a search stack may generate a search query on behalf of the user. The search stack, for example, may generate a search query based on context information associated with the user. This may be performed for example, by search engine 204 of FIG. 2.

Regardless of how the query is generated, in step 504, the search engine may then retrieve data matching the search results query. The data returned may be based on a match (whether explicit or implicit) between the query (and/or other factors, such as user context and a user profile) and terms in an index accessible to the search engine, such as data index 206 of FIG. 2.

The process then flows to step 506, in which the search stack may retrieve one or more models appropriate to the user's search. In the exemplary implementation of FIG. 2, appropriate model(s) may be selected by the model selector 210 in connection with an index (e.g., model index 212) relating a user's query and/or data returned by the search engine to one or more appropriate model(s).

At step 508, the search stack may then apply the retrieved model(s) to the retrieved data. In the exemplary implementation of FIG. 2, this step may be performed by model execution engine 216. In addition to the retrieved data itself, other factors relating to the search such as the user query (or one or more portions thereof) may also serve as input to one or more computations performed as a result of executing the model on the retrieved data. Processing at step 508 may entail multiple iterations. In some embodiments, a model may apply to each item of data, such as a web page included in retrieved data 208. Accordingly, processing at step 508 may be iterative in the sense that it is repeated for each item contained within retrieved data 208. Alternatively or additionally, processing at step 508 may be iterative in that application of a model, whether applied to an individual item of data or a collection of items of data, may entail iteratively applying statements in the model until a stable and consistent result is achieved. Processing at step 508 may alternatively or additionally be iterative in the sense that multiple models may be selected by model selector 210 such that information in compliance with each of the selected models may be generated by processing at step 508.

Turning to step 510, the search stack may then output results generated as a result of the application of the selected model(s) to the retrieved data. In this example the output may entail returning information to a user computer which can then render the information on a display for a user. In some embodiments, the generated information may include some combination of the result of executing the model on the data returned from the search engine and the data itself. For example, the generated information may filter or reorder the search data based on the application of the model, or may provide additional information or information in a different format than the data returned by the search results. In some embodiments, the reordering of the search data may incorporate a time element. For example, a model may identify a time order of a set of multiple events. Application of such a model may then entail identifying search data related to those events, and generating the information returned to the user in an order in accordance to the time order of the model. Though, it should be recognized that the nature of the information generated may be in any suitable form that can be specified as a result of application of a model, which may contain a combination of elements, such as calculations, equations, constraints and/or rules.

After the data is returned to the user (via the user's computing device), the process of FIG. 5 may be done.

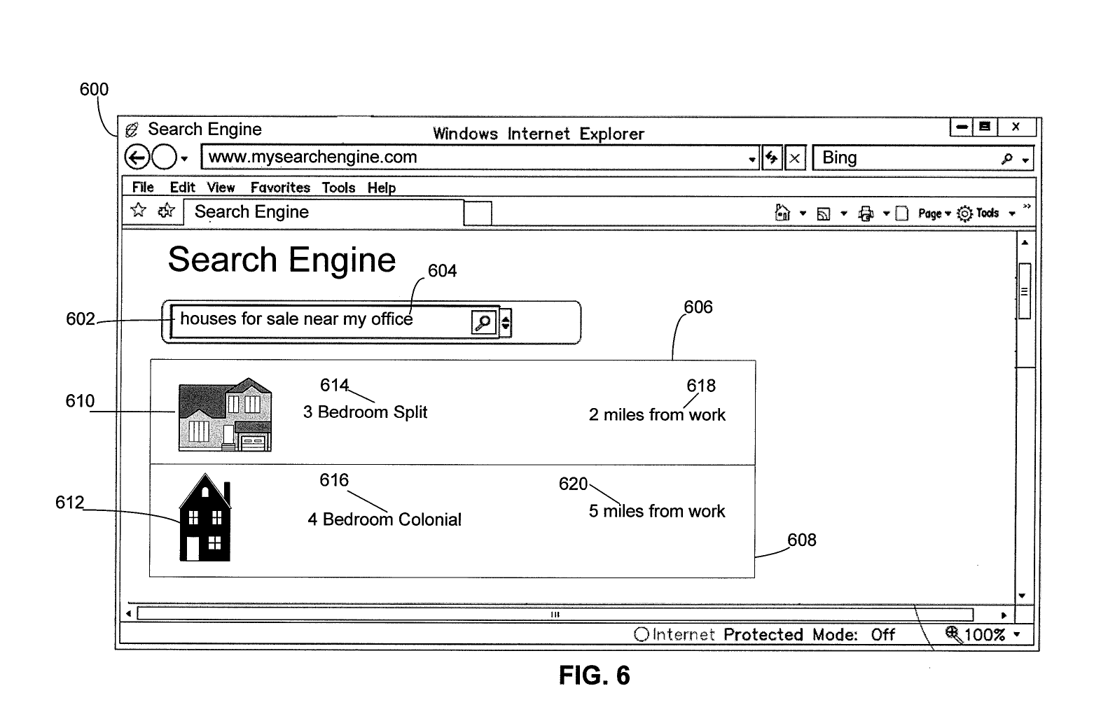

FIG. 6 is an example of a user interface via which a user may access a search in a retrieved system. In this example, a user may enter a search query and view information returned in response to the query. FIG. 6 illustrates that the interface is displayed by a web browser 600, although any suitable application to generate a user interface may be used. The web browser 600 may be any suitable web browser, illustrated in this example as being INTERNET EXPLORER® developed by Microsoft Corporation, and may execute on a computing device operated by the user (such as computing device 105 of FIG. 1). In the example of FIG. 6, the web browser has loaded a web page returned by a search and retrieval system such as that illustrated in FIG. 2.

The user has entered a text query 604, “houses for sale near my office,” in a query input field 602 in the user interface, and sent that query via web browser 600 to a search engine that is part of a search stack according to some embodiments. In response, the search stack returned generated information to the user via the web browser, illustrated in FIG. 6 as returned information elements 606 and 608, which are displayed in the web browser.

After receiving the user's query, the search engine may retrieve a set of data (e.g., web pages) including results of houses for sale near the user's office. The set of data returned from the search engine may be based on matches between the query terms and terms in an index relating to the web pages, as discussed above. Though, as illustrated, other sources of data may be used in evaluating the search query. In this example, the search query includes the phrase “my office.” That phrase may be associated with information in a user profile accessible to the search and retrieval system processing the query. Accordingly, on execution of the query, the search and retrieval system may filter results based on geographic location in accordance with the information specified in the user profile. Though, it should be recognized that any suitable technique may be used to process a search query and retrieve data.

Based on the query and/or the retrieved data, an appropriate model may then be selected by the search stack, such as by model selector 210 of FIG. 2. In the example of FIG. 6, the model specified in FIG. 4 relating houses for sale to a user's commute is selected based on the portion of the query text, “near my office.”

The selected model is then retrieved and applied to the data (i.e., the web pages of houses for sale) resulting from the search. The application of the model to the data may be performed, for example, by model execution engine 216. In the example of FIG. 6, the user's office location may also be a value of an input parameter to the selected model. Because the query text “near my office” does not specify the exact office location, in this example, the user's office location may be taken from the user's profile or the user's context, for example. In this example, as discussed in connection with FIG. 4, applying the selected model comprises determining the GPS coordinates of the address, city and state of each house for sale from the search results, computing the commuting distance between each house and the user's office, and arranging the generated information to display the commuting distance alongside the description of each house for sale. In the example of FIG. 6, the display of the generated information has also been sorted based on commuting distance.

Thus, in the example of FIG. 6, two listings of houses for sale are returned by the search stack and displayed in the web browser, returned information elements 606 and 608. Each of returned information 606 and 608 includes a picture 610 and 612, respectively, of the house for sale and a description 614, and 616, respectively, of the house for sale. In addition, returned information elements 606 includes commuting information 618, “2 miles from work,” displayed alongside description 614, and returned information 608 includes commuting information 620, “5 miles from work,” displayed alongside description 616. In the example of FIG. 6, returned information elements 606 and 608 are returned as being sorted in ascending order based on commuting distance.

Accordingly, as the result of the application of the model specified by the example of FIG. 4, more useful information is returned to the user. That is, instead of merely returning a list of houses for sale, based on additional dynamic computations performed that are specific to the user or his query (i.e., based on his office location), performed based or dynamically identified data (houses for sale in this example), additional information (i.e., commute information) may be provided to the user than would otherwise be possible, and the results may be arranged accordingly. Accordingly, applying the selected model has allowed the user to receive additional information and presented in a manner that is more pertinent to his search query.

The search stack may also be configured to modify the index of models, such as model index 212 of FIG. 2 based on user feedback. Though FIG. 2 illustrates indexer 252 updating model index 212 by “crawling” a pool of models 250, indexer 252 may be adapted to update model index 212 using alternative or additional techniques. For example, based on user feedback that a first model may be more useful than a second model for a particular type of query, the model index may be modified to favor selection of the first model over the second model for that particular query. The user feedback may be either explicit, such as via an explicit voting mechanism, or implicit, such as may be obtained by tracking the behavior of a user interacting with the generated information returned as a result of applying a particular model. For example, if a user mouse clicks on the first piece of generated information returned to the user, and does not click on any other links for a specified period of time, this may be taken as an indication that the first piece was of sufficient interest to the user that he spent a significant amount of time reviewing the information.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other non-transitory, tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A search and retrieval system comprising:
at least one processor for implementing a plurality of computer-executable components, the components comprising:
an input component adapted to receive from a user input defining a search query;
a data search engine adapted to generate a data portion of search results based on the search query;
a model selection component adapted to select a model defining information to be generated from among a plurality of models, the model selection component selecting the model based at least in part on the search query and/or the data portion of the search results;
a model execution engine adapted to execute the selected model to generate information; and
an output component adapted to return to the user in response to the received search query at least the information generated by the model execution engine.

2. The search and retrieval system of claim 1, further comprising a computer storage medium encoded storing the plurality of models, each of the plurality of models comprising declarative statements.

3. The search and retrieval system of claim 1, further comprising a computer storage medium encoded storing the plurality of models, each of the plurality of models comprising a combination of elements, the elements including one or more of calculations, equations, constraints and rules.

4. The search and retrieval system of claim 2, wherein:
at least a first of the plurality of models comprises an equation; and
when the first model is executed by the model execution engine, the model execution engine performs a mathematical operation on data in the data portion of the search results to generate information.

5. The search and retrieval system of claim 2, wherein:
at least a third of the plurality of models comprises a rule; and
when the third model is executed by the model execution engine, the model execution engine triggers a search by the data search engine in response to an evaluation of the rule.

6. The search and retrieval system of claim 2, wherein:
at least a fourth of the plurality of models comprises a calculation; and
when the fourth model is executed by the model execution engine, the model execution engine performs a numerical calculation on the data portion of the search results to generate information.

7. The search and retrieval system of claim 1, wherein the data portion of search results based on the search query comprises data related to medical records of a plurality of users.

8. The search and retrieval system of claim 7, wherein executing the selected model comprises generating a metric comparing a lab result of the user to lab results in the medical records.

9. The search and retrieval system of claim 1, wherein:
the system further comprises:
an index of data pages relating each of a plurality of search terms to one or more data pages; and
an index of models, relating each of a plurality of search terms to one or more models of the plurality of models;
the data search engine generates the data portion of search results based at least in part on the index of data pages; and
the model selection component selects a model based at least in part on the index of models.

10. A method of operating a search system, the method comprising:
at least one processor, in response to a search query:
identifying a declarative model of information based at least in part on the search query;
dynamically identifying data based at least in part on the search query;
generating information in compliance with the model based at least in part on the dynamically identified data; and
generating a result based on the generated information.

11. The method of claim 10, wherein the generating information comprises:
performing a computation using as an input to the computation the dynamically identified data.

12. The method of claim 10, wherein the generating information comprises:
performing an Internet search with a search query generated by application of the declarative model to the dynamically identified data.

13. The method of claim 10, wherein:
the model identifies a time order of a plurality of events; and
the generating information comprises ordering elements within the dynamically identified data relating to the plurality of events in accordance with the time order of the model.

14. The method of claim 10, wherein:
the search query is received from a user over the Internet; and
the method further comprises conveying the result to the user over the Internet.

15. The method of claim 10, further comprising:
inferring a search query based on contextual information received from a user over the Internet.

16. At least one non-transitory computer storage medium comprising computer-executable instructions that, when executed by at least one processor, perform a method within a search stack in a search system, the method comprising:
processing information representing a search query to:
identify a model based on an index of models;
dynamically identify data based on an index of data pages;
generating information by evaluating declarative statements representing equations in the identified model based on the dynamically identified data.

17. The at least one non-transitory computer storage medium of claim 16, wherein the method further comprises generating information comprising calculating a numerical value based on an expression in the identified model.

18. The at least one non-transitory computer storage medium of claim 16, wherein the method further comprises generating the search query based on context information associated with a user.

19. The at least one non-transitory computer storage medium of claim 16, wherein the generating information is further based on received input comprising the search query and a user context.

20. The at least one non-transitory computer storage medium of claim 16, wherein the method further comprises modifying the index of models based on user feedback.
